(19) United States
(12) Patent Application Publication
(10) Pub. No.: US 2006/0052884 A1
(43) Pub. Date: Mar. 9, 2006

(54) User interface builder application for building automation

(76) Inventors: Mathew L. Staples, Fort Collins, CO (US); Jason M. Turner, Henderson, CO (US)

Correspondence Address: TRENNER LAW FIRM, LLC, 12081 WEST ALAMEDA PARKWAY #163, LAKEWOOD, CO, 80228, US

(21) Appl. No.: 11/209,444

(22) Filed: Aug. 23, 2005

Related U.S. Application Data
(60) Provisional application No. 60/607,913, filed on Sep. 8, 2004.

(51) Int. Cl. G05B 11/01; G05B 15/00

(52) U.S. Cl. 700/83; 700/19; 700/20; 700/17

(57) ABSTRACT

Implementations described and claimed herein provide a computer program product encoding computer programs for executing a drag-and-drop computer process of generating a custom user interface for a building automation system. The drag-and-drop computer process comprises selecting an automation device in the building automation system and at least one function for the automation device. The drag-and-drop computer process comprises moving an icon representing the automation device onto a custom user interface, and moving a graphic for the at least one function onto the custom user interface. The drag-and-drop computer process comprises generating program code to link the graphic to the at least one function for the automation device.

### PRIORITY APPLICATION

This application claims priority to co-owned U.S. Provisional Patent Application Ser. No. 60/607,913 for “User Interface Builder Application For Building Automation” of Mathew L. Staples and Jason M. Turner (Attorney Docket No. CVN.017.PRV), filed Sep. 8, 2004, hereby incorporated herein for all that is disclosed.

### TECHNICAL FIELD

The described subject matter relates to building automation, and more particularly to a user interface builder application for building automation.

### BACKGROUND

The ability to automatically control one or more functions in a building (e.g., lighting, heating, air conditioning, security systems) is known as building automation. Building automation systems may be used, for example, to automatically operate various lighting schemes in a house. Of course building automation systems may be used to control any of a wide variety of other functions, more or less elaborate than controlling lighting schemes.

Building automation systems may be provided with switches, dials and knobs for controlling automation devices. Such controls are typically hard-wired to specific automation devices to control the devices in a prescribed manner, and therefore cannot be readily customized or changed for individual users or changes to the building automation system (e.g., adding or removing automation devices).

More sophisticated building automation systems may be provided with computer controls. However, configuring and reconfiguring such computer controls requires advanced programming skills, increasing the cost of installation and maintenance.

### SUMMARY

Implementations described and claimed herein encode computer programs for executing a drag-and-drop computer process of generating a custom user interface for a building automation system. In some implementations, articles of manufacture are provided as computer program products. One implementation of a computer program product encodes a computer program for selecting an automation device in the building automation system and at least one function for the automation device, moving an icon representing the automation device onto a custom user interface, moving a graphic for the at least one function onto the custom user interface, and generating program code to link the graphic to the at least one function for the automation device.

In another exemplary implementation, a method of generating a custom user interface for a building automation system is provided. The method may be implemented to select an automation device in the building automation system and at least one function for the automation device, assign the automation device to a custom user interface, place a graphic for the at least one function in the custom user interface, and link the graphic to the at least one function for the automation device.

In still another exemplary implementation a building automation system with a touch panel display for controlling an automation device is provided. The system includes a custom user interface provided at the touch panel display. The system also includes a user interface engine operatively associated with the custom user interface at the touch panel display and with the automation device, the user interface engine receiving user input through the custom user interface and issuing command signals to the automation device to execute a function corresponding to the user input.

### BRIEF DESCRIPTION OF THE DRAWINGS

FIG. 1 is a schematic illustration of an exemplary building automation system.

FIG. 2 is a functional diagram illustrating an exemplary implementation of a user interface builder application.

FIG. 3 is a high-level diagram illustrating program code generation.

FIGS. 4-7 are exemplary graphical user interfaces that may be used to generate a custom user interface for a building automation device.

FIG. 8 is a flow diagram illustrating operations for generating a user interface for a building automation device.

### DETAILED DESCRIPTION

In exemplary implementations shown and described herein a touch-panel display device, such as e.g., a thin film transistor (TFT) display, may replace conventional light switches or other controllers for automation devices in a building automation system. A user interface for the touch-panel display device may be customized with a user interface builder application. The user interface builder application allows the installer (or other user) to generate a custom user interface by “dragging and dropping” graphical icons representing automation devices and functions onto a generic user interface. In other implementations a filter wizard may be provided to guide the user in generating the custom user interface.

The user or a technician may program any function onsite or remotely and in real time (e.g., via an external link to the building automation system). For example, the building owner may call a technician to make changes to a user interface. If the building owner approves the changes the new user interface may be loaded to the touch panel display.

Although exemplary implementations are described herein with reference to building automation systems, it should be understood that the scope is not limited to use with building automation systems and the invention may also find application in a number of different types of electronic computing systems now known or later developed.

Exemplary Building Automation System

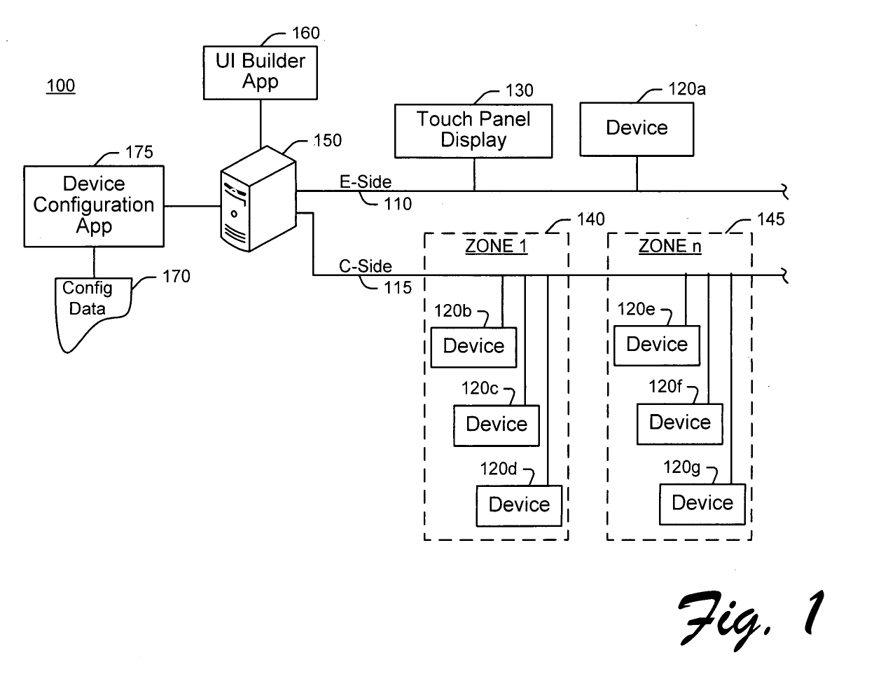

FIG. 1 shows an exemplary building automation system 100 as it may be used to automate various functions in a home or other building (e.g., apartment complex, hotel, office building). By way of example, the building automation system 100 may be used to control lighting, heating, air conditioning, audio/visual distribution, operating window coverings to open/close, and security, to name only a few examples.

Building automation system 100 may include one or more communication networks, such as Ethernet network 110 (referred to herein as the “E-Side”) and a controller area network or CAN bus 115 (referred to herein as the “C-Side”). Ethernet networks are well understood. Implementations of a building automation system including a CAN bus are described in more detail in co-owned U.S. patent application Ser. No. 10/382,979, entitled “Building Automation System and Method” of Hesse, et al. filed on Mar. 5, 2003.

Briefly, the CAN bus may be implemented using a two-wire differential serial data bus. The CAN bus is capable of high-speed data transmission (about 1 Megabits per second (Mbits/s)) over a distance of about 40 meters (m), and can be extended to about 10,000 meters at transmission speeds of about 5 kilobits per second (kbits/s). It is also a robust bus and can be operated in noisy electrical environments while maintaining the integrity of the data.

It is noted that building automation system 100 is not limited to use with any particular type of communications network. Other networks may include, e.g., RS-232 networks, and wireless networks to name only a few examples.

Building automation system 100 may include one or more automation devices, such as E-side devices 120a and C-side devices 120b-g (hereinafter generally referred to as automation devices 120). The automation devices 120 may include any of a wide range of types and configurations of devices. Examples include, e.g., security sensors, temperature sensors, light sensors, timers, touch pads, and voice recognition devices, to name only a few.

Automation devices may also include a touch panel display 130. Touch panel display 130 may be implemented, e.g., as a TFT touch panel display, although other implementations are also contemplated. Touch panel display 130 may be used to control one or more automation devices 120 in the building automation system 100 using a custom user interface described in more detail below. Before continuing it is noted that the automation devices, including the touch panel display 130, may be coupled to the network and/or to other devices by hardwiring and/or remote link (e.g., an IR connection).

Automation devices 120 may be provided in building automation zones 140, 145. Building automation zones 140, 145 may be defined geographically, such as by room (e.g., the living room) or group of rooms (e.g., the first floor of a house). Alternatively, zones may be defined by functionality, such as security devices or lighting devices. In any event, any number of zones 140, 145 may be defined for the building automation system 100 and touch panel display 130 may be implemented to control devices in any one or more of the zones 140, 145.

Automation devices 120 and the touch panel display 130 may be communicatively coupled to one another in the building automation system 100 via a bridge 150 to facilitate communications between the different types of networks. The term “bridge” as used herein refers to both the hardware and software (the entire computer system) and may be implemented as one or more computing systems, such as a server computer.

It is noted therefore that the bridge 150 may also perform various other services for the building automation system 100. For example, bridge 150 may be implemented as a server computer to process commands for automation devices and the touch panel display 130, provide Internet and email services, broker security, and optionally provide remote access to the building automation system 100.

A user interface builder application 160 may be implemented for the building automation system 100 to generate a custom user interface for the touch panel display 130. UI builder 160 is described in more detail below. Briefly, however, the UI builder 160 receives device configuration data 170, e.g., from a device configuration application 175 used for configuring automation devices 120 in the building automation system 100. UI builder 160 displays the device configuration data 170 as graphical icons which the user may drag and drop onto a generic user interface or user interface template to generate a custom user interface.

The custom user interface may be stored at the touch panel display 130 for operation. A backup copy of the custom user interfaces may also be stored at the bridge 150. If a touch panel display 130 is replaced, the custom user interface may be automatically reloaded to eliminate the need for reprogramming by the installer.

It is noted that the building automation system 100 is not limited to any particular type or configuration. The foregoing example is provided in order to better understand one type of building automation network in which the UI builder application 160 described herein may be implemented. However, the systems and methods may also be implemented in other types of building automation systems. The particular configuration may depend in part on design considerations, which can be readily defined and implemented by one having ordinary skill in the art after having become familiar with the teachings of the invention.

Exemplary Software Implementation

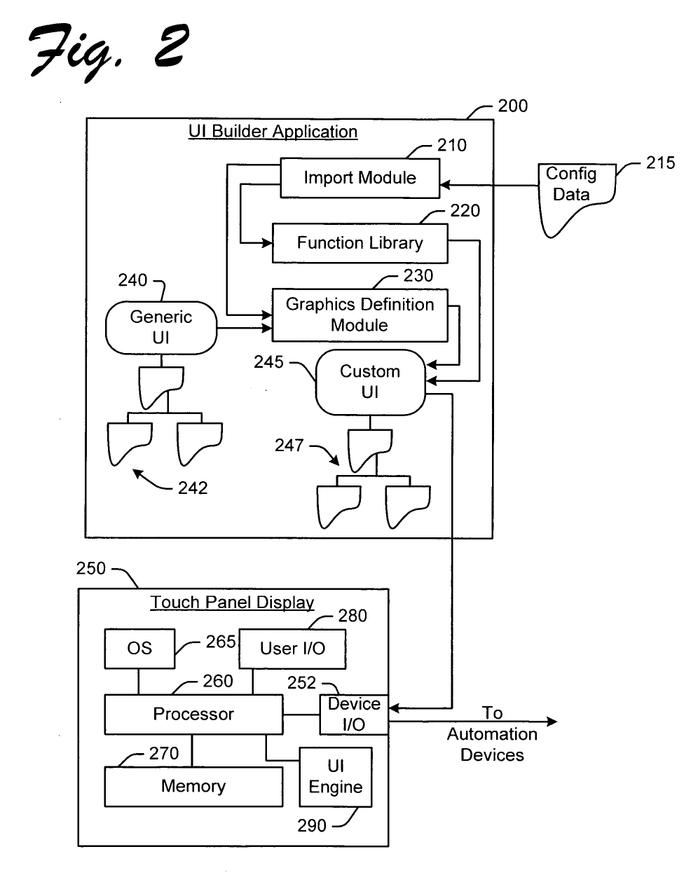

FIG. 2 is a functional diagram illustrating implementation of an exemplary user interface builder application 200 for generating a custom user interface for a building automation system. Exemplary user interface builder 200 (also referred to herein as UI builder) may be implemented as computer-readable program code product (e.g., software) for execution in a Microsoft Windows or other graphical user interface operating environment.

UI builder 200 may include functional modules, such as, e.g., an import module 210, a function library 220, and a graphics definition module 230. Import module 210 may interface with a configuration application (such as device configuration application 175 in FIG. 1) to receive configuration data 215 for the building automation system. Alternatively, import module 210 may receive configuration data 215 from other sources such as, e.g., a data file generated by the installer. Import module 210 provides the configuration data 215 to the function library 220 and to the graphics definition module 230.

Function library 220 may be implemented to handle device functions for the automation devices. Function library 220 may display device functions that a user may assign to a generic user interface 240. Function library 220 may also be implemented to generate code for executing the functions in the building automation system during operation.

Graphics definition module 230 may be implemented to handle graphics. Graphics definition module 230 may display a generic user interface 240 for a user to customize. Generic user interface 240 may be implemented, e.g., as a template user interface. Generic user interface 240 may include a number of “pages” 242. Graphical icons may be added by the graphics definition module to the pages 242 in the generic user interface 240.

The functional modules of UI builder application 200 may be implemented to generate a custom user interface 245 having a number of pages 247 with graphics for displaying information (e.g., temperature data from a temperature sensor in the building automation system) and providing functionality for a touch panel display 250. For example, selecting a graphic may display another page 247 in the custom user interface 245. Selecting a graphic may also issue command(s) to an automation device to control various functions in the building automation system.

Before continuing, it is noted that exemplary UI builder 200 is shown and described herein merely for purposes of illustration and is not intended to limit the UI builder to any particular implementation. For example, import module 210, function library 220, and graphics definition module 230 do not need to be encapsulated as separate functional components. In addition, other functional components may also be provided and are not limited to those shown and described herein.

The custom user interface 245 generated by the UI builder application 200 may be delivered to one or more touch panel displays 250 in the building automation system, e.g., connected via device I/O 252. Touch panel display 250 may include a processor or processing units 260, including an operating system 265 (e.g., Linux). Processor 260 is operatively associated with computer readable storage or memory 270, e.g., where the custom user interface may be stored. Processor 260 is also operatively associated with a user I/O device 280, such as, e.g., a TFT screen for displaying output and/or receiving user input.

Touch panel display 250 may execute the custom user interface by implementing a UI Engine 290. UI Engine 290 may include program code generated by the UI builder application 200 and corresponding to the custom user interface 245. UI Engine 290 may include program code for navigating through the pages 247 in the custom user interface 245. UI Engine 290 may also include program code for generating signals to control automation devices.

To illustrate operation, a user may press a “hot” area on the TFT screen corresponding to a graphical button displayed on the custom user interface 245 to activate a lighting control device. The user input may be received via user I/O 280. In response to this input, UI engine 290 may cause another page 247 in the custom user interface 245 to be displayed for the user (via user I/O 280) indicating that the button has been selected. UI engine 290 may also cause a signal to be issued (e.g., on CAN bus 115 in FIG. 1) identifying the user selection to the automation devices. A lighting control device in the building automation system receives the signal and executing program code (e.g., scripts) residing at the lighting control device causes the lights to be turned on.

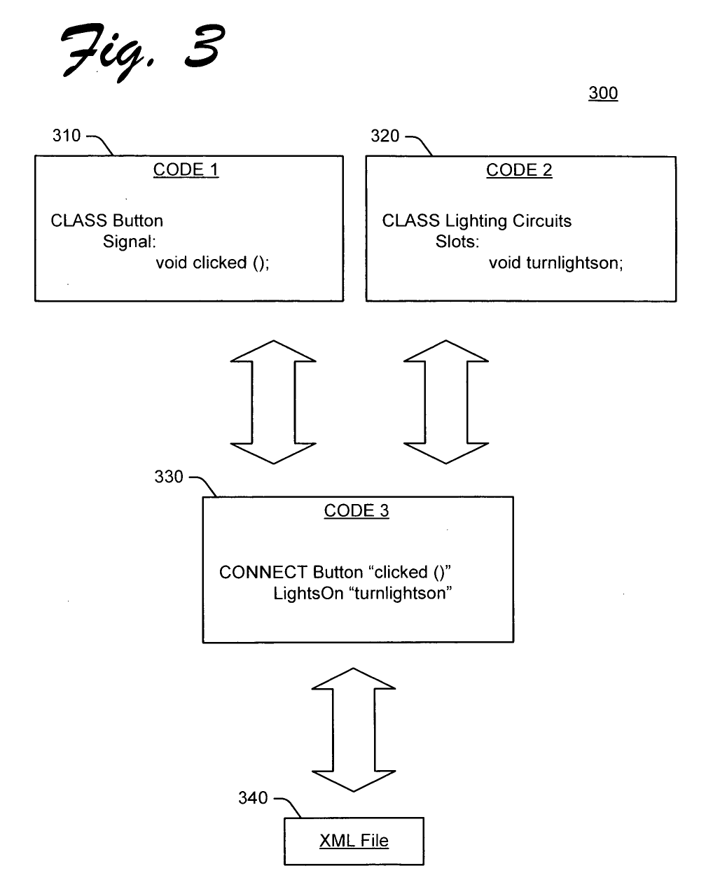

FIG. 3 is a high-level diagram illustrating program code for a custom user interface. A UI builder application (such as UI builder 200) may generate program code defining object classes and corresponding processes for implementing a custom user interface for a touch panel display in a building automation system. For purposes of illustration, the UI builder may generate the program code shown in FIG. 3 so that the lights are turned on when a user selects a button displayed in the custom user interface.

In FIG. 3, program code 310 includes object class “Button” and the corresponding process “clicked” corresponding to the user selecting a button in the custom user interface by “clicking” or otherwise making a selection. Program code 320 includes object class “Lighting Circuits” and corresponding process “turnlightson”. Program code 310 and 320 may be compiled to produce program code 330, which defines a function for a button selection in the custom user interface.

UI builder application may use the compiled program code 330 to generate an XML file 340. XML file 340 may be delivered to the touch panel display and stored in memory. Executing the program code may display a custom user interface at the touch panel display and receive user input for controlling functions in the building automation system.

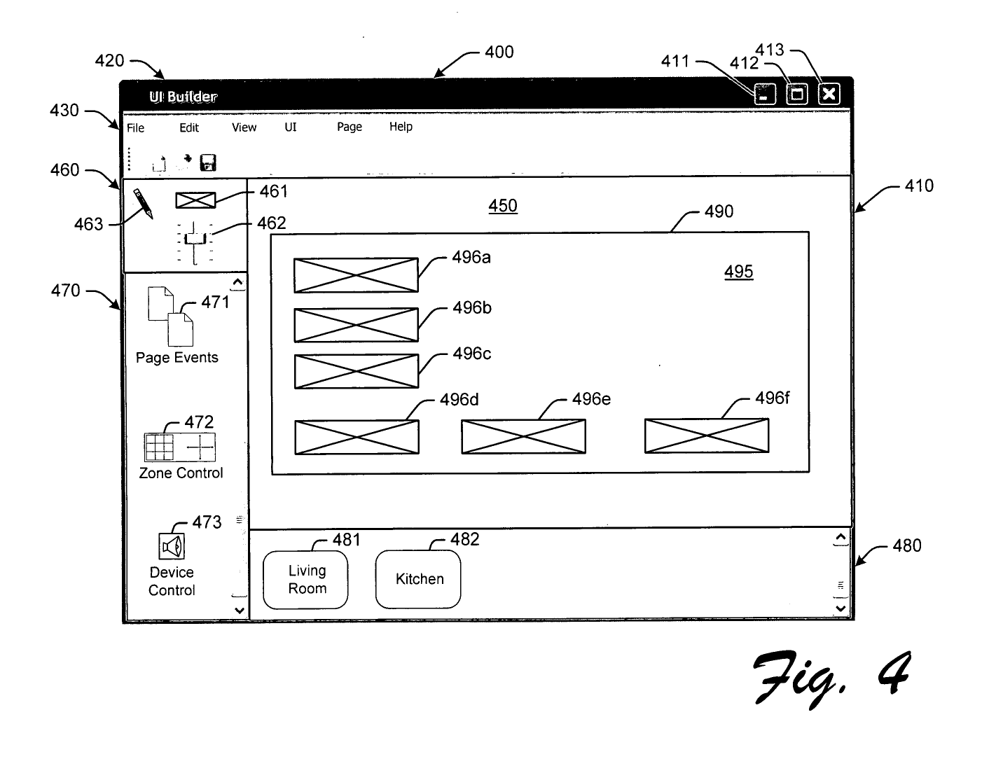

FIGS. 4-7 are exemplary graphical user interfaces that may be displayed by the user interface builder application to generate a user interface for a building automation device. The graphical user interface may be implemented in a windows operating system environment (e.g., Microsoft Corporation's WINDOWS®), although the user interface is not limited to use with any particular operating system.

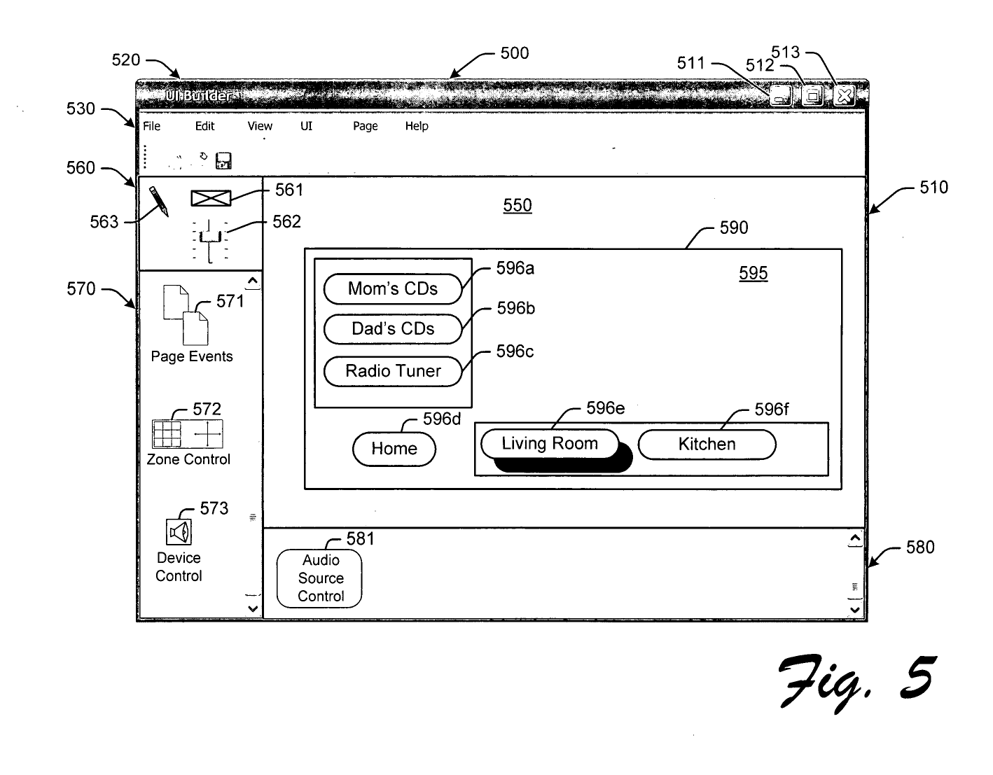

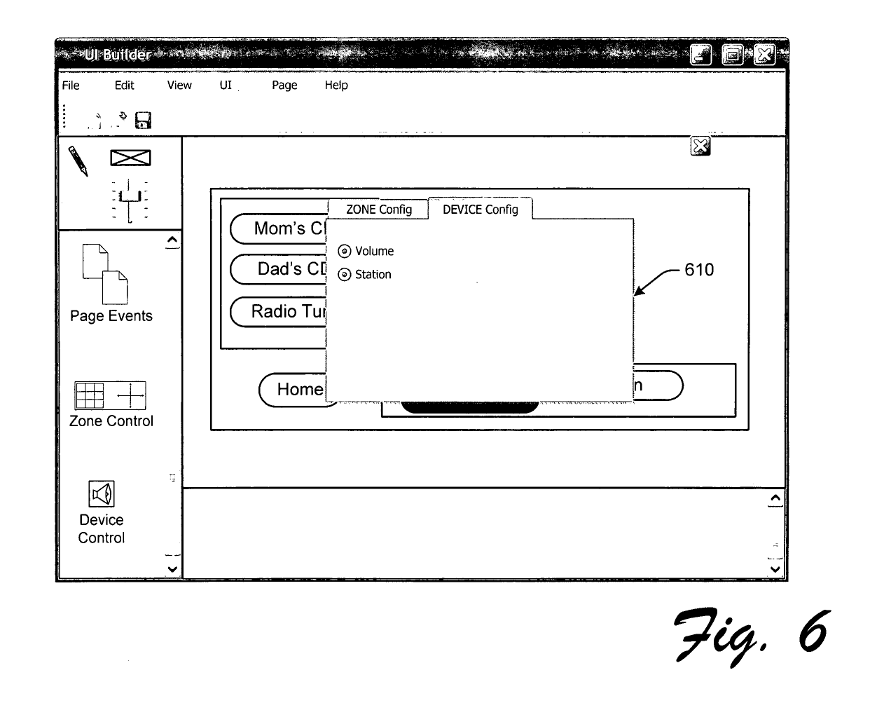

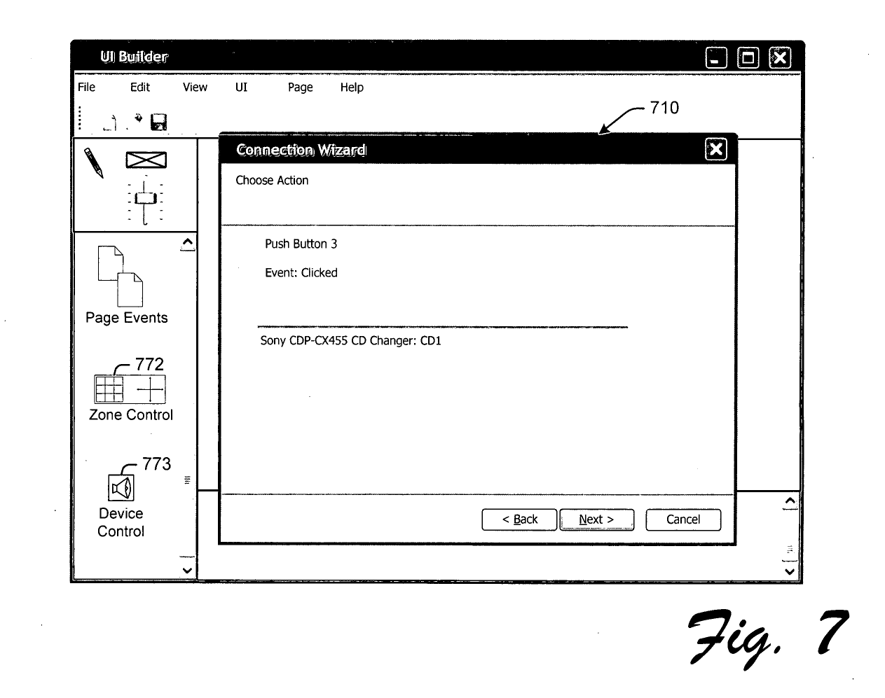

The graphical user interface is described generally with reference to FIG. 4, although it is noted that like reference numerals are used to refer to like components in each of the figures, with 400-series used in FIG. 4, 500-series used in FIG. 5, 600-series used in FIG. 6, and 700-series used in FIG. 7.

With reference to FIG. 4, graphical user interface 400 is associated with an interface application (e.g., the UI builder application 200 in FIG. 2). The user may launch the graphical user interface 400 in a customary manner, for example, by clicking on an icon, selecting the program from a menu, or pressing a button on a keypad.

The graphical user interface 400 supports user interaction through common techniques, such as a pointing device (e.g., mouse, style), keystroke operations, or touch screen. By way of illustration, the user may make selections using a mouse to position a graphical pointer and click on a label or button displayed in the graphical user interface 400. The user may also make selections by entering a letter for a menu label while holding the ALT key (e.g., “ALT+letter” operation) on a keyboard. In addition, the user may use a keyboard to enter command strings (e.g., in a command window).

The graphical user interface 400 is displayed for the user in a window, referred to as the “application window” 410, as is customary in a window environment. The application window 410 may include customary window functions, such as a Minimize Window button 411, a Maximize Window button 412, and a Close Window button 413. A title bar 420 identifies the application window 410. The application window 410 may also include a customary menu bar 430 having an assortment of pull down menus 440 (e.g., labeled “File”, “Tools”, and “Help”). For example, the user may select a print function (not shown) from the “File” menu.

Application window 410 also includes an operation space 450. Operation space 450 may include one or more graphics for displaying output and/or facilitating input from the user. Graphics may include, but are not limited to, subordinate windows, dialog boxes, icons, text boxes, buttons, and check boxes. Exemplary operation space 450 includes subordinate windows for drawing tools 460 (e.g., button tool 461, slider tool 462, pencil tool 463), page tools 470 (e.g., page events 471, zone control 472, device control 473), and function tools 480. Exemplary operation space 450 also includes a preview area 490 for displaying a customizable user interface 495.

A user, such as the integrator or building owner, may generate a custom user interface for a touch panel display (e.g., 250 in FIG. 2) using the graphical user interface 400 to execute the user interface application (e.g., 200 in FIG. 2). For purposes of illustration, a user may select File|New from the menu bar 430 to open a new or generic user interface 495. The user may then add graphics to the generic user interface 495 to customize the generic user interface (e.g., custom user interface 595 in FIG. 5). In FIG. 4 buttons 496a-f are shown added to the generic user interface 495, e.g., by selecting the button tool 461 from the drawing tools 460 and dragging and dropping the buttons onto the generic user interface 495 displayed in preview area 490.

The user may also select from any of a variety of page tools 470. Page tools 470 may include page events 471, for example, to display a home page for the I/O device or display the home page of another device in the building automation system. In an exemplary implementation, the user may assign page events to the user interface by selecting the page events button 471 from the page tools 470 and dragging and dropping it onto one of the buttons in the generic user interface 495 displayed in preview area 490. In FIG. 5, for example, custom user interface 595 is shown including a “Home” button 596d.

Page tools 470 may also include zone control 472, e.g., to assign a zone to the user interface. For purposes of illustration, the user may select zone control 473 to display zones in area 480. Exemplary zones may include a “Living Room” zone 481 and a “Kitchen” zone 482. The user may assign one or more of the zones to the generic user interface 495 by dragging and dropping the corresponding icon onto the generic user interface 495 displayed in preview area 490. In FIG. 5, for example, a customized user interface 595 is shown including a “Living Room” button 596e and a “Kitchen” button 596f.

Page tools 470 may also include device controls 473, e.g., to assign automation devices to the user interface. For purposes of illustration, the user may select a zone icon in area 480 to show automation devices corresponding to the selected zone. Exemplary automation devices may include “Audio Source Control” 581 in FIG. 5. Again, the user may assign one or more of the automation devices to the generic user interface 495 by dragging and dropping the corresponding icon onto the generic user interface 495 displayed in preview area 490. In FIG. 5, for example, a customized user interface 595 is shown including a “Mom's CDs” button 596a, a “Dad's CDs” button 596b, and a “Radio Tuner” button 596c.

The buttons 596 may be defined to perform various functions when selected. For purposes of illustration, button 596e is shown selected in FIG. 5 and the audio devices available in the living room are displayed on the user interface (e.g., as buttons 569a-c).

The user may also assign functions to the device buttons 596a-c. In exemplary implementations, the user may select a button by “right-clicking” the button to call a subordinate window or configuration wizard having further configuration options for the automation device. It is noted, however, that configuration options are not limited to subordinate windows or configuration wizard implementations.

FIG. 6 illustrates an exemplary configuration window. As discussed above, the user may “right click” on a custom button 696 displayed in preview area 690 to display configuration window as a subordinate window in the graphical user interface 600. The configuration window may include configuration options, such as, e.g., zone configuration options and device configuration options. In FIG. 6, the “Device Configuration” tab is shown selected for the “Tuner” button. Configuration options may include, e.g., volume, band, station. In FIG. 6, “Volume” is shown selected.

FIG. 7 illustrates an exemplary configuration wizard. As discussed above, the user may “right click” on a custom button 796 displayed in preview area 790 to display a configuration wizard in the graphical user interface 700. The configuration wizard may help guide the user in making configuration selections in a predetermined order. In FIG. 7, the connection wizard is shown requesting a device to access when “Push Button 3” is “clicked” on the custom user interface. A drop-down menu is shown for the user to make a selection of available devices. The user can return to previous steps by selecting the “Back” button, or proceed to the next step by selecting the “Next” button.

Exemplary Operations

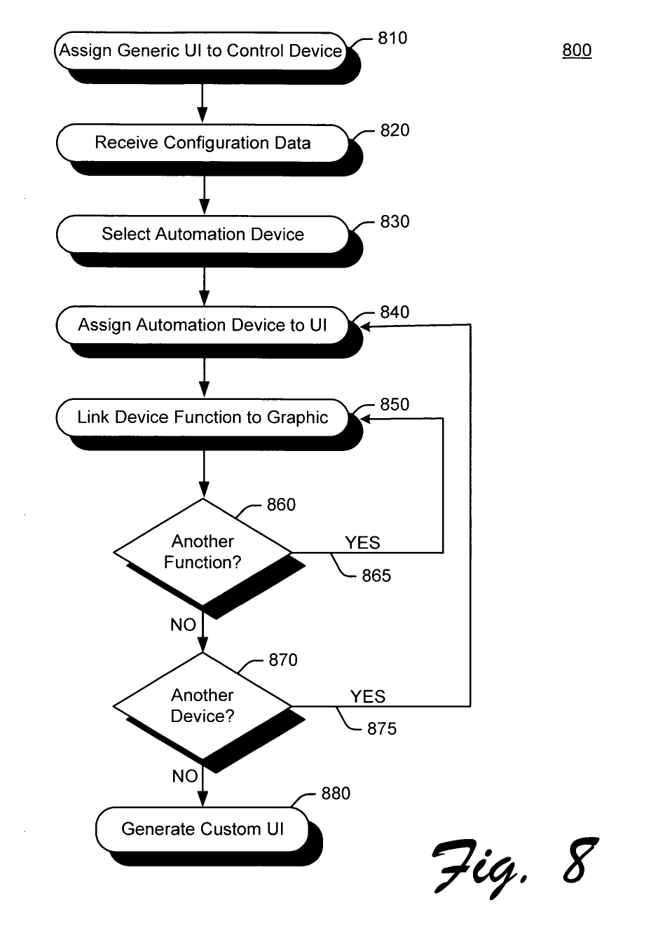

FIG. 8 is a flow diagram illustrating operations 800 for generating a user interface. The methods described herein may be embodied as logic instructions. When executed on a processor (or processing devices), the logic instructions cause a general purpose computing device to be programmed as a special-purpose machine that implements the described methods.

In operation 810 a generic user interface is assigned to an I/O device (e.g., a TFT display device). It is noted that the generic user interface may be, e.g., a template. In operation 820 configuration data for the building automation system is received. For example, configuration data may be imported from a device configuration application or a data file for the building automation system. In operation 830 an automation device is selected (e.g., a lighting controller). For example, the automation device may be selected from a list of automation devices in the building automation system based on the configuration data imported in operation 820.

In operation 840 the automation device is assigned to the user interface. In operation 850 a device function is linked to the user interface. For example, a user may select a graphical icon representing the automation device and then drag and drop another graphical icon representing a device function onto the operational space defining the user interface.

In operation 860 the user is queried whether another function should be assigned to the user interface. If the answer is yes, operations return 865 to operation 850. Otherwise the user is queried in operation 870 whether another device should be assigned to the user interface. If the answer is yes, operations return 875 to operation 840. Otherwise in operation 880 program code is generated for the custom user interface, which may then be delivered to the selected I/O device for execution.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

What is claimed is:

1. A method of generating a custom user interface for a building automation system comprising:
selecting an automation device in the building automation system and at least one function for the automation device;
assigning the automation device to a custom user interface;
placing a graphic for the at least one function in the custom user interface; and
linking the graphic to the at least one function for the automation device.

2. The method of claim 1, further comprising importing configuration data for a building automation network, the automation device and at least one function for the automation device selected from the imported configuration data.

3. The method of claim 1, wherein assigning the automation device to a custom user interface is by dragging and dropping an icon representing the automation device onto the custom user interface.

4. The method of claim 1, wherein placing the graphic for the at least one function is by dragging and dropping an icon representing the automation device onto the custom user interface.

5. The method of claim 1, wherein linking the graphic to the at least one function for the automation device is by dragging and dropping an icon representing the function onto the custom user interface.

6. The method of claim 1, further comprising selecting a template for the custom user interface.

7. The method of claim 1, wherein each step is facilitated by a wizard interface.

8. The method of claim 1, wherein the building automation device is selected from a plurality of zones in the building automation system.

9. The method of claim 1, further comprising delivering the custom user interface to a touch panel display in the building automation system.

10. The method of claim 1, further comprising linking the function to an application.

11. The method of claim 1, further comprising linking to another page in the custom user interface.

12. The method of claim 1, further comprising linking a display graphic to a data source for displaying external data in the custom user interface.

13. A computer program product encoding computer programs for executing a drag-and-drop computer process of generating a custom user interface for a building automation system, the drag-and-drop computer process comprising:
selecting an automation device in the building automation system and at least one function for the automation device;
moving an icon representing the automation device onto a custom user interface;
moving a graphic for the at least one function onto the custom user interface; and
generating program code to link the graphic to the at least one function for the automation device.

14. The computer program product of claim 13 wherein the computer process further comprises importing configuration data for the building automation system for selecting the automation device and at least one function.

15. The computer program product of claim 13 wherein the computer process further comprises selecting a template for the custom user interface.

16. The computer program product of claim 13 wherein the computer process further comprises displaying a wizard interface for selecting the automation device and at least one function.

17. The computer program product of claim 13 wherein the computer process further comprises selecting the automation device from a plurality of zones in the building automation system.

18. The computer program product of claim 13 wherein the computer process further comprises delivering the custom user interface to a touch panel display in the building automation system.

19. The computer program product of claim 13 wherein the computer process further comprises linking the at least one function to an application in the building automation system.

20. The computer program product of claim 13 wherein the computer process further comprises linking to another page in the custom user interface.

21. The computer program product of claim 13 wherein the computer process further comprises linking a display graphic to a data source for displaying external data in the custom user interface.

22. A building automation system with a touch panel display for controlling an automation device comprising:
a custom user interface provided at the touch panel display; and
a user interface engine operatively associated with the custom user interface at the touch panel display and with the automation device, the user interface engine receiving user input through the custom user interface and issuing command signals to the automation device to execute functions corresponding to the user input.
